(19) United States
(12) Patent Application Publication
(10) Pub. No.: US 2009/0119938 A1
(43) Pub. Date: May 14, 2009

(54) Digital Clinometer

(76) Inventor: Ci-Moo Song, (US)

Correspondence Address: ARENT FOX LLP, 1050 CONNECTICUT AVENUE, N.W., SUITE 400, WASHINGTON, DC, 20036, US

(21) Appl. No.: 11/885,876

(22) PCT Filed: Mar. 8, 2006
(86) PCT No.: PCT/KR06/00809

§ 371 Date: Sep. 7, 2007

(30) Foreign Application Priority Data
Mar. 9, 2005 (KR) 10-2005-0019441

(51) Int. Cl. G01C 9/06

(52) U.S. Cl. 33/366.14

(57) ABSTRACT

The present invention relates to an integral digital clinometer. The integral digital clinometer includes at least one acceleration sensor; an Analog-to-Digital (AfD) converter for converting detected signals from the acceleration sensor into digital signals; computing means for processing the digital signals in order to obtain an inclination value of a measurement line or a measurement plane with respect to a reference line or plane; display means for displaying the inclination value; power supply means; and a housing configured to accommodate the acceleration sensor, the A/D converter, the computing means and the power supply means, mounted so that display of the display means is visible, and configured to have a mounting portion supported along the measurement line or the measurement plane. The integral digital clinometer can be used as the ball marker of a golf green by miniaturizing the structure thereof and forming a lower disk base portion and a pin portion at the center of the disk base portion. The integral digital clinometer of the present invention can precisely display the inclination difference between a reference (absolute) horizontal plane or a reference (absolute) vertical plane and the ground, the bottom of a building, or the base of one of various electromechanical apparatuses in numerals, test, or graphics.

### CROSS-REFERENCE TO RELATED APPLICATION

This application is a National Stage entry of International Application Number PCT/KR2006/000809. filed March 8, 2006. The disclosure of the prior application is hereby incorporated herein in its entirety by reference.

### TECHNICAL FIELD

The present invention relates to a digital clinometer and, more particularly, to an integral digital clinometer which senses an inclination with respect to a reference plane in real time using an acceleration sensor and displays the direction and magnitude of the inclination in numerals, text, or graphics.

### BACKGROUND ART

Existing level or inclination measuring devices include a conventional level in which liquid and air are charged together in a glass tube, and which allows a human to determine an inclination with respect to a horizontal plane using his or her eyes and the principle by which air bubbles float up in liquid.

As an improved inclination angle measuring device, a mercury inclination angle sensing device, in which a circular channel is formed in a glass substrate, mercury is charged in the channel, and an inclination with respect to a horizontal plane is determined based on the location of the mercury within the channel, is disclosed in Korean Unexamined Patent Publication No. 2001-104588. Furthermore, in Korean Unexamined Patent Publication Nos. 2002-12841 and 2002-43733, a two-axis level sensor using optical technology is disclosed. However, the technologies have complicated structures, so that breakdowns may frequently occur and the prices thereof cost are high.

### DISCLOSURE OF INVENTION

### Technical Problem

An object of the present invention is to provide an integral digital clinometer, the structure of which is simple and reliable and which displays the direction and magnitude of an inclination angle with respect to a reference line or a reference plane in real time. Another object of the present invention is to provide an integral digital clinometer, which can be used as a ball marker for displaying a green inclination in a golf green. Still another object of the present invention is to provide a personal portable information terminal having a clinometer function.

### Technical Solution

In order to accomplish the above objects, the present invention provides An integral digital clinometer, including at least one acceleration sensor; an Analog-to-Digital (A/D) converter for converting detected signals from the acceleration sensor into digital signals; computing means for processing the digital signals in order to obtain an inclination value of a measurement line or a measurement plane with respect to a reference line or plane; display means for displaying the inclination value; power supply means; and a housing configured to accommodate the acceleration sensor, the A/D converter, the computing means and the power supply means, mounted so that display of the display means is visible, and configured to have a mounting portion supported along the measurement line or the measurement plane.

A basic acceleration sensor includes an external casing, an object having a constant internal mass, a suspension spring coupling the external casing and the internal mass, and a mechanical-electronic energy conversion element outputting an electrical signal proportional to the amount of deformation when the suspension spring is deformed. Such an acceleration sensor can be manufactured using MicroElectroMechanical Systems (MEMS) technology.

A servo-type sensor, which has a structure most similar to that of the basic acceleration sensor, and which measures variation in magnetic field when a moving object mounted in a coil moves due to acceleration, may be used as the acceleration sensor. Besides such a mechanical acceleration sensor, a silicon acceleration sensor may be used. The mechanical properties of the silicon acceleration sensor are excellent and conventional semiconductor integrated circuit processing technology is used therein, so that reliability and mass-productivity are excellent, and it is advantageous with respect to the miniaturization, weight saving and cost reduction of elements. Such silicon acceleration sensors are mainly classified into a capacitive type manufactured by surface-micromachining poly-silicon, which is of benefit in generating a film, and a piezoresistive type manufactured by forming a piezoresistive element on a single silicon crystal and film-processing it using bulk-micromachining. Such a silicon acceleration sensor can sense two-dimensional or three-dimensional acceleration using a single sensor depending on the structure thereof.

An acceleration sensor for sensing one-dimensional acceleration is described. When the acceleration sensor is in a stationary state, only gravity acts thereon. Therefore, gravity does not act along a plane perpendicular to the direction of gravity, so that the plane becomes a reference plane that is absolutely horizontal. The sensor signal value of the acceleration sensor, the axis of which is located in the direction of the plane, is a reference value or 0. Besides the reference plane, which is absolutely horizontal, any other reference plane may be determined. When the acceleration sensor is a one-axis sensor, one-dimensional inclination, that is, the inclination of a measurement line can be measured. The acceleration sensor is preferably two sensors or a two-axis sensor, the sensing axes of which are different. Calibration is achieved when the sensing axes are parallel with the mounting portion thereof, or are in a parallel condition.

The present invention converts analog signals, output from an acceleration sensor, into digital signals, processes the digital signals using a computer computing means, and displays the magnitude of an angle with respect to a reference horizontal plane or a reference vertical plane in numerals, text, or graphics. In the simplest case, the angle is represented in a numeral, and in more complicated cases, the angle is represented in a map form according to map-scaling. The computing means is preferably a microcomputer, which converts digital signal values into proper angle units using a proportion operator, or transmits the coordinate values of the map-scaling established according to the direction and magnitude on the concentric circle map of a display, and displays them. The display means includes, for example, a Liquid Crystal Display (LCD), Light Emitting Diodes (LED) or Organic Light Emitting Diodes (OLED). The display means displays an inclination angle in a numeral form using a graphic LCD and displays an inclination direction in a dot form on a direction plate configured like a clock display plate in order to miniaturize a measurement device. Alternatively, it is possible to display them on a dot-type graphic LCD or LED concentrically arranged.

Noise components not related to external pure inertia force, pure gravity, or pure impulsive force can be eliminated using a filter or the software of the computing means.

The preferable structure of the present invention is a structure in which a printed circuit board, on which a two-axis sensing acceleration sensor, an A/D converter, and a computing means are mounted, is accommodated in a housing, a flat display element, such as an LCD, LED, or OLED, is mounted on the upper portion of the printed circuit board such that a display device is upwardly exposed, a battery box, on which a battery, which is the power supply means, is detachably mounted, is mounted on the lower portion of the printed circuit board, a mounting portion supported along a measurement line or plane is provided on the lower portion of the housing, and a switch for switching a power supply is mounted on the upper surface of the housing.

The clinometer precisely can display the inclination angle between a reference (absolute) horizontal plane or a reference (absolute) vertical plane and the ground, bottom of a building or the plane of one of various electromechanical apparatuses in numerals, text, or graphics.

In the simplest structure for such a clinometer, the lower portion of a housing is formed in a disk shape, a fastening pin portion downwardly extending from the center of the lower disk portion is provided, and a circular display device is mounted on the upper portion of the housing. This clinometer can be manufactured in a small size, and used as a ball marker in a golf green. The circular display device includes a concentric circle map so that the inclination angle and magnitude can be measured based on the location of a point (or a cursor) from the center thereof. Alternatively, the inclination angle is displayed in numerals and the inclination direction is displayed in dot form on a direction plate configured like a clock display plate. Alternatively, it is displayed on a dot-type graphic LCD or LED, the pixels of which are concentrically arranged. The ball marker precisely measures the inclination direction and magnitude of a green on which the ball is located, thereby greatly assisting a golfer to easily perform putting.

Furthermore, the present invention provides a personal portable information terminal, including at least one acceleration sensor; an A/D converter for converting detected signals from the acceleration sensor into digital signals; and a main body having a mounting portion supported along a measurement line or a measurement plane, thereby having a clinometer function; wherein the acceleration sensor, the A/D converter and the main body are integrated with the personal portable information terminal, such as a mobile phone or a Personal Digital Assistant (PDA) in order to use display means and computing means of the terminal.

The present invention is described in detail with reference to drawings.

FIG. 1 is a diagram illustrating the operational principal of a mechanical acceleration sensor used in the present invention. Depending on the direction and magnitude of gravity, a mass (weight) moves and a displacement is generated. The acceleration is sensed by converting the displacement into electrical signals.

FIGS. 2 and 3 are diagrams illustrating an embodiment of the present invention. An acceleration sensor 1, an A/D converter 2, a battery box 3, a micro-computer 4 and a switch 5 are mounted in a printed circuit board which is accommodated in the housing of a clinometer 10. A concentric circle map shape is formed as the background of a display 6 which is mounted in the upper portion of the housing 7. A switch tap 51 is exposed on a side of the upper portion of the housing. A disk-shaped plate which is parallel with the sensing axis of the acceleration sensor is formed as a mounting portion 8 on the lower portion of the housing.

FIG. 4 is a block diagram illustrating the signal processing of an acceleration sensor according to the present invention. Analog signals output from at least one acceleration sensor 1 are converted into digital signals by the A/D converter 2. The digital signals are processed by the micro-computer 4, and then are displayed by the display 6 in various forms, such as numerals, text, or graphics.

FIGS. 5 and 6 illustrate a golf ball marker 20 according to the present invention, in which a printed circuit board having thereon a two-axis acceleration sensor, an A/D converter and a micro-computer, is accommodated in a housing 7. The mounting portion 8 of the housing is formed in a lower disk form. A fastening pin portion 11 is provided at the center of the lower disk portion. A switch tap 51 is provided on a side of the housing, and a circular display device is provided on the upper portion thereof, thereby displaying a green inclination angle with coordinates on the map of a golf green. The pin portion 11 is detachably connected to the housing and includes a battery box (not shown) at the connection, thereby enabling exchange of a battery.

FIGS. 7 and 8 are diagrams illustrating a personal portable information terminal having a clinometer function according to the present invention. Mounting portions 12 are placed on a measurement plane and inclination angle and magnitude are displayed on the map 61 of a display 6′.

### ADVANTAGEOUS EFFECTS

The clinometer of the present invention can precisely display the inclination angle between a reference (absolute) horizontal plane or reference (absolute) vertical plane and the ground, the bottom of a building or the base of one of various electro-mechanical apparatuses in numerals, text or graphics.

### BRIEF DESCRIPTION OF THE DRAWINGS

FIG. 1 is a schematic diagram illustrating the operational principle of an acceleration sensor used in the present invention;

FIG. 2 is a perspective view illustrating an embodiment of the present invention;

FIG. 3 is a layout of a printed circuit board in the embodiment;

FIG. 4 is a schematic flowchart according to the present invention;

FIGS. 5 and 6 are perspective views of a golf ball marker according to the present invention;

FIG. 7 is a perspective view illustrating a personal digital assistant having a clinometer function according to the present invention; and

FIG. 8 is a perspective view in which FIG. 7 is viewed from below.

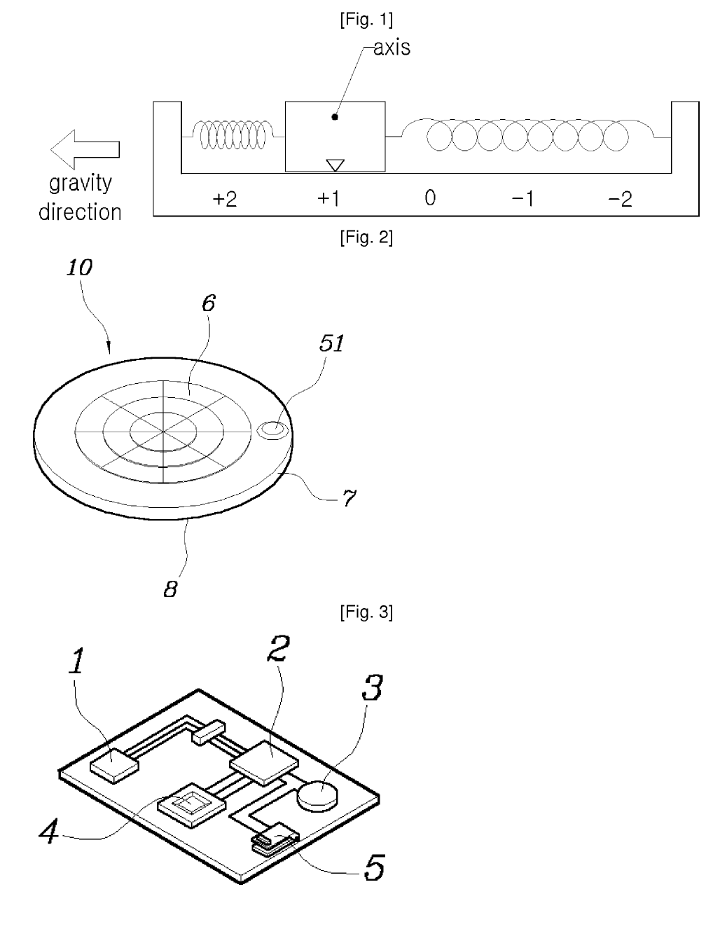

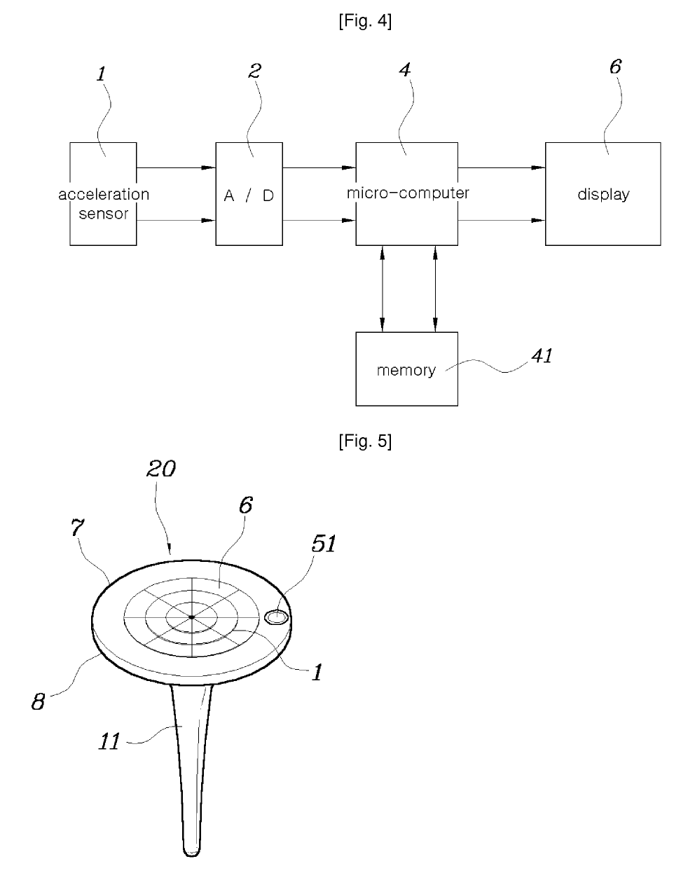

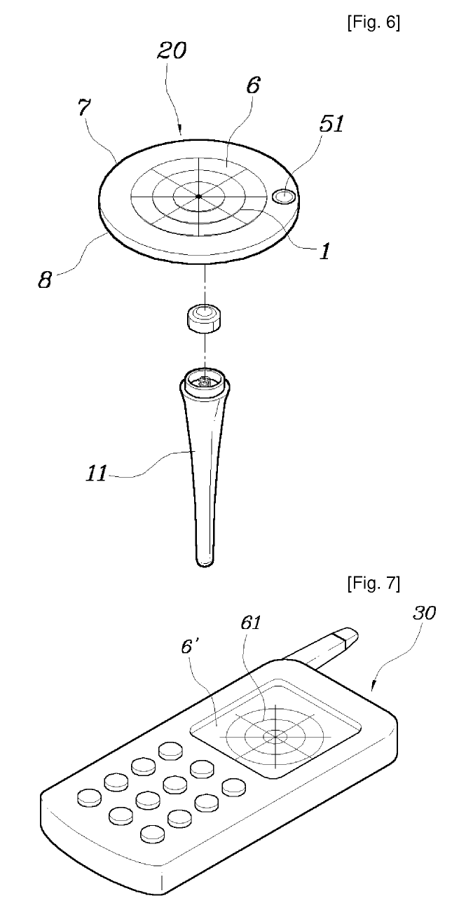

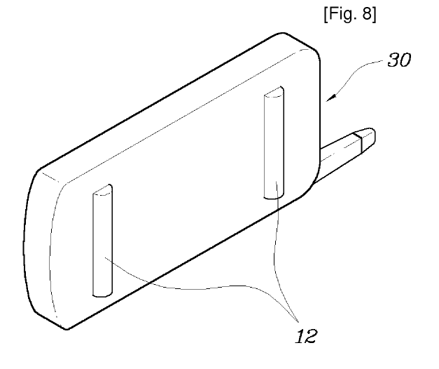

1. An integral digital clinometer, comprising at least one acceleration sensor; an Analog-to-Digital (A/D) converter for converting detected signals from the acceleration sensor into digital signals; computing means for processing the digital signals in order to obtain an inclination value of a measurement line or a measurement plane with respect to a reference line or plane; display means for displaying the inclination value; power supply means; and a housing configured to accommodate the acceleration sensor, the A/D converter, the computing means and the power supply means, mounted so that display of the display means is visible, and configured to have a mounting portion supported along the measurement line or the measurement plane.

2. The integral digital clinometer as set forth in claim 1, wherein the acceleration sensor is a two-axis sensor, a sensing axis of which is placed in a plane parallel to the mounting portion, the computing means is a micro-computer which calculates values of the digital signals and transmits inclination direction and magnitude values, and the display means displays the inclination direction and magnitude values in numerals, text or graphics.

3. The integral digital clinometer as set forth in claim 2, wherein the display means is a Liquid Crystal Display (LCD), Light Emitting Diodes (LED), or Organic Light Emitting Diodes (OLED).

4. The integral digital clinometer as set forth in claim 3, wherein the display means is a graphic LCD and displays the inclination angle in a numeral form and the inclination direction in a dot form on a direction plate configured like a clock display plate.

5. The integral digital clinometer as set forth in claim 4, wherein the display means is a graphic LCD or LED and performs display using dots, pixels of which are concentrically arranged.

6. The integral digital clinometer as set forth in claim 3, wherein a printed circuit board, on which a two-axis sensing acceleration sensor, the A/D converter, and the computing means are mounted, is accommodated in the housing, the mounting portion of the housing is formed in a lower disk shape, a fastening pin portion is provided at a center of the lower disk, and an indicating element is provided in an upper portion of the housing, so that it can be used as a ball marker which indicates a green inclination angle in a golf green.

7. A personal portable information terminal, comprising at least one acceleration sensor; an A/D converter for converting detected signals from the acceleration sensor into digital signals; and a main body having a mounting portion supported along a measurement line or a measurement plane, thereby having a clinometer function; wherein the acceleration sensor, the A/D converter and the main body are integrated with the personal portable information terminal, such as a mobile phone or a Personal Digital Assistant (PDA) in order to use display means and computing means of the terminal.
